(19) United States
(12) Patent Application Publication
(10) Pub. No.: US 2006/0131508 A1
(43) Pub. Date: Jun. 22, 2006

(54) Systems and methods for improving position resolution of charge-sharing position sensitive detectors

(76) Inventors: Kent Charles Burr, Latham, NY (US); Adrian Ivan, Niskayuna, NY (US); James Walter LeBlanc, Niskayuna, NY (US)

Correspondence Address: Patrick S. Yoder;FLETCHER YODER, P.O. Box 692289, Houston, TX, 77269-2289, US

(21) Appl. No.: 11/021,540

(22) Filed: Dec. 22, 2004

(51) Int. Cl. G01T 1/20

(52) U.S. Cl. 250/370.11

(57) ABSTRACT

An imaging system configured to provide improved position resolution is disclosed. The imaging system includes detector acquisition circuitry that is configured to acquire a plurality of rise-times and a plurality of amplitudes from a detector assembly that includes an array of one or more detector elements. The imaging system also includes position determining circuitry that is configured to determine a plurality of respective impact positions on each of the detector elements. The plurality of impact positions is based on at least the plurality of rise-times and the plurality of the amplitudes acquired by the detector acquisition circuitry.

### BACKGROUND

The invention relates generally to the field of imaging and more specifically to position sensitive detectors.

The field of non-invasive imaging has broad and wide ranging applications in the areas of medical and industrial imaging. For example, in modern healthcare facilities, medical diagnostic and imaging systems are invaluable for diagnosing, and treating physical conditions and disorders inside the human body. In industrial applications, imaging is a valuable tool for scanning various objects for quality control and defect recognition. Commonly used imaging systems include computed tomography (CT) systems, x-ray systems, magnetic resonance imaging (MRI) systems, ultrasound systems, optical imaging systems, positron emission tomography (PET) systems, and single positron emission computed tomography (SPECT) systems. These various imaging systems can be used appropriately in both medical and industrial imaging applications.

A primary advantage of non-invasive imaging is that internal structures can be readily identified without damaging or removing intervening material, such as tissue, clothing, metal, ceramics, plastics, and so forth. Spatial accuracy of a non-invasive imaging system is typically measured in terms of the system's spatial resolution. In addition, spatial accuracy may be a function of the position sensing mechanism employed to generate the signals used to construct images. For instance, in imaging systems in which the impact of radiation or particle emissions is detected to generate images, the resolution of the mechanism used to localize the impact may determine the spatial accuracy and resolution of the generated images.

For example, position sensing in a nuclear imaging system, such as a positron emission tomography (PET) or single photon emission computed tomography (SPECT) system, may be based on the detection of optical photons emitted in response to the impact of gamma rays upon a scintillator. The position where the optical photons are detected may be used to determine the position of the gamma ray impact, which in turn may be used to determine the point of origin of the gamma ray and to generate an image.

Therefore, as will be appreciated, limitations or deficiencies in position determination at the photodetection step (i.e., the detection and localization of the optical photons) may ultimately reduce the spatial resolution of the generated image.

Therefore, as will be appreciated by those of ordinary skill in the art, improvements in the position sensing capabilities of photodetectors used in imaging systems may be desirable to improve spatial resolution and image quality.

### BRIEF DESCRIPTION

In accordance with certain embodiments of the present technique, an imaging system configured to provide improved position resolution is disclosed. The imaging system includes detector acquisition circuitry that is configured to acquire a plurality of rise-times and a plurality of amplitudes from a detector assembly that includes an array of one or more detector elements. The imaging system also includes position determining circuitry that is configured to determine a plurality of respective impact positions on each of the detector elements. The plurality of impact positions is based on at least the plurality of rise-times and the plurality of the amplitudes acquired by the detector acquisition circuitry.

In accordance with another embodiment of the present technique, a method for determining the position of a photon impact on an array of one or more detector elements is disclosed. The method includes the step of acquiring a plurality of rise times and a plurality of amplitudes from the array of detector elements. The method also involves the step of determining the position of a photon impact on each of the detector elements based on the plurality of rise-times and the plurality of the amplitudes.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of an exemplary positron emission tomography (PET) imaging system operating under certain aspects of the present technique;

FIG. 2 is a diagrammatical illustration of exemplary profiles of varying resistance of the resistive layer in an position sensitive avalanche photodiode;

FIG. 3 is a diagrammatical illustration of an imaging system, wherein position of photon impact is resolved using rise-time information and amplitude information from impact positions of photons on position sensitive detectors;

FIG. 4 is a diagrammatical illustration of an exemplary PET detector system for determining position of photon impact using rise-time and amplitude information; and

FIG. 5 is a diagrammatical representation depicting timing information for the exemplary PET detector system illustrated in FIG. 4.

### DETAILED DESCRIPTION

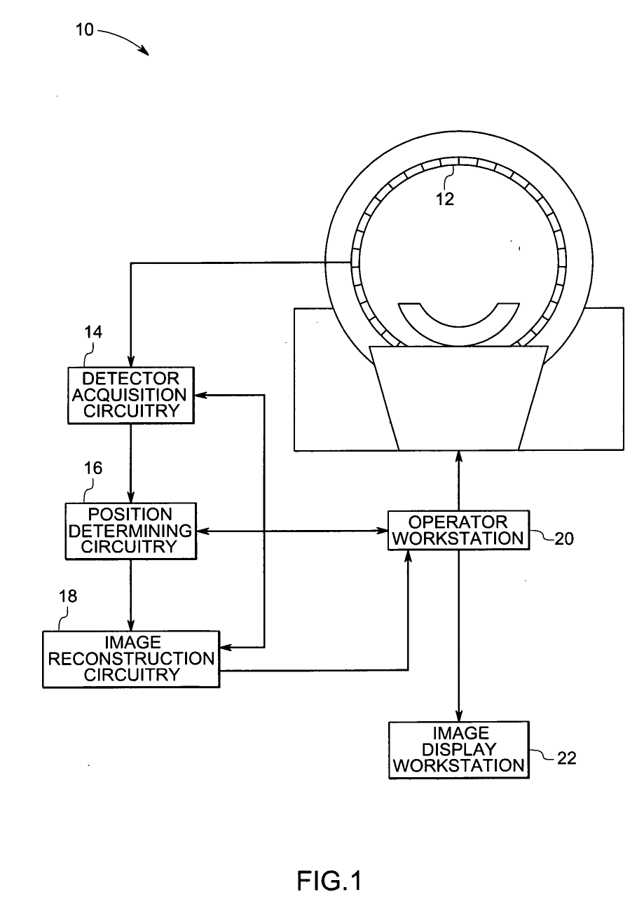

Turning now to the drawings and referring first to FIG. 1, an exemplary PET system 10 operating with certain aspects of the present technique is illustrated. The PET system 10 includes a detector assembly 12, detector acquisition circuitry 14, position determining circuitry 16, and image reconstruction circuitry 18. The detector assembly 12 typically includes a number of detector elements arranged in one or more rings, as depicted in FIG. 1. The PET system 10 also includes an operator workstation 20 and an image display workstation 22. While in the illustrated embodiment, the detector acquisition circuitry 14, the position determining circuitry 16 and the image reconstruction circuitry 18 are shown as being outside the detector assembly 12 and the operator workstation 20, in certain implementations, some or all of these circuitries may be provided as part of the detector assembly 12 and/or the operator workstation 20. Each of the aforementioned components would be discussed in greater detail in the sections that follow.

Keeping in mind the exemplary PET system 10 above, or the corresponding components of other types of nuclear imaging systems, a brief description of the functioning of such a system is provided to facilitate further discussion of the present technique. For example, PET imaging is primarily used to measure metabolic activity that occur in tissues and organs.

In particular, PET imaging typically generates functional images of biological and metabolic activity as opposed to the structural images generated by imaging modalities such as magnetic resonance imaging (MRI) and computed tomography (CT). In PET imaging, the patient is typically injected with a solution that contains a radioactive tracer that emits positrons. The solution is distributed and absorbed throughout the body in different degrees, depending on the tracer employed and the functioning of the organs and tissues. For instance, tumors typically process more glucose than a healthy tissue of the same type. Therefore, a glucose solution containing a radioactive tracer may be disproportionately metabolized by a tumor, allowing the tumor to be located and visualized by the radioactive emissions. In particular, the radioactive tracer emits particles known as positrons that interact with and annihilate complementary particles known as electrons to generate gamma rays. In each annihilation reaction, two 511 keV gamma rays traveling in opposite directions are emitted. In a PET imaging system 10, the pair of gamma rays are detected by the detector assembly 12 configured to ascertain that two detected gamma rays detected sufficiently close in time are generated by the same annihilation reaction. Due to the nature of the annihilation reaction, the detection of such a pair of gamma rays may be used to determine the line along which the gamma rays traveled before impacting the detector, allowing localization of the annihilation event to that line. By detecting a number of such gamma ray pairs, and calculating the corresponding lines, typically referred to as “lines of response” traveled by these pairs, the concentration of the radioactive tracer in different parts of the body may be determined and a tumor, thereby, may be detected. Therefore, accurate detection and localization of the gamma rays forms a fundamental and foremost objective of the PET system 10.

In view of these comments, and returning now to FIG. 1, the detector acquisition circuitry 14 is adapted to read out signals from the detector elements of the detector assembly 12. These signals are generated in response to gamma ray impacts and the resulting optical photon emission and detection described above. In one embodiment, the detector elements include an array of position sensitive avalanche photodiodes (PSAPDs) that are adapted to detect the optical photons and to amplify the signal to increase the ratio of signal to electronic noise. The signals acquired by the detector acquisition circuitry 14 are provided to position determining circuitry 16, which determines photon impact positions based on the signals. Image reconstruction circuitry 18 identifies coincident gamma ray pairs within the correct energy range and generates an image based on the photon impact positions and the corresponding derived gamma ray emission lines of response. The operator workstation 20 is utilized by a system operator to provide control instructions to some or all of the described components and for configuring the various operating parameters that aid in data acquisition and image generation. The operator workstation 20 may also display the generated image. Alternatively, the generated image may be displayed at a remote viewing workstation, such as the image display workstation 22.

As noted above, in one embodiment, scintillators convert emitted gamma rays to optical photons that are subsequently detected by PSAPDs to provide photon impact position information used to generate images. Each PSAPD consists of a deep diffused, high gain avalanche photodiode (APD) with the front optical entrance surface having a top electrical contact overlying drift and space charge regions. The back surface of the PSAPD consists of a resistive layer with four corner contacts (or anodes) that provide position resolution based on comparison of the signal rise time and/or amplitude measured at each corner anode for a photon impact. In this manner, the PSAPD produces four position-related signals that vary in a continuous manner for events across the surface of the PSAPD. As a result, photon impact position information for a large imaging area can be decoded from just the four corner contacts of the PSAPD, although a fifth signal from the top surface of the PSAPD is usually recorded to provide a measure of the total energy incident on the PSAPD.

For example, based on the impact position of photons on the top contact of the PSAPD, electrical signals of different intensities reach the four corner contacts. For instance, a photon that impacts the center of the top surface of the PSAPD generates electrical signals of equal intensities at each of the four corner contacts. When the impact position of a photon on the top surface of the PSAPD is offset from center, signal intensities are inversely proportional to the distance from the impact to a corner contact, such that the corner(s) closer to the impact are associated with greater signal intensity. Similarly, the rise-time (which is a measure of delay in arrival of the signals at each of the corner contacts) is dependent on the location of the photon impact, with the rise-time or delay inversely proportional to the distance from the impact position to a corner contact. Although measurements of the electric signal amplitude and rise-time provide similar information, it is important to realize that the measurements are always made in the presence of noise (including shot or Poisson noise in the photon statistics and electronic noise in the detector and acquisition system). Because the noise contributions in the amplitude and rise-time measurements are not substantially correlated, the measurements provide complementary information and techniques which use a combination of measurements of amplitude and rise-time can eliminate some fraction of the noise or reduce some fraction of the noise by averaging out some of the noise. This results in improved estimates of the position of impact of the photons on the PSAPD.

As will be appreciated by one of ordinary skill in the art, these variations in signal corner contact signal intensity based on impact position are determined by the resistive layer on the back of the PSAPD. In certain exemplary implementations of the present technique, the resistive layer used in the construction of the PSAPD may be a uniform resistive layer in which the resistance of the resistive layer is substantially the same across at each point on the resistive layer. In other implementations, the resistive layer may be a non-uniform resistive layer in which the resistance of the resistive layer is different at different points. For example, a non-uniform resistive layer may be configured such that resistance increases or decreases radially from the center of the resistive layer or from some or all of the corner contacts.

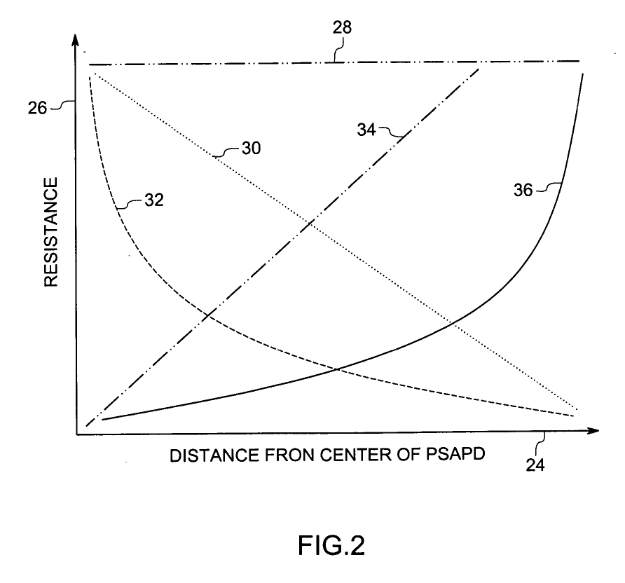

Referring now to FIG. 2, a graph depicting different exemplary resistance profiles in accordance with the different embodiments of the invention discussed above is provided. In FIG. 2, horizontal axis 24 represents distance from the center of the PSAPD and vertical axis 26 represents the resistance of the resistive layer. A substantially uniform resistive layer, as discussed above is depicted by plot 28 which depicts a resistance profile that remains substantially constant throughout the PSAPD. A non-uniform resistive layer in which the resistance of the resistive layer is highest at the center of the PSAPD and linearly decreases with distance from the center of the PSAPD is depicted by plot 30. Similarly, plot 32 represents a resistance profile where the resistance is highest at the center of the PSAPD and decreases exponentially as the distance from the center of the PSAPD increases. Conversely, plot 34 represents a resistance profile where the resistance of the resistive layer increases linearly with distance from the center such that resistance is lowest at the center of the PSAPD and highest at the periphery of the PSAPD. Similarly, plot 36 represents a resistance profile where the resistance increases exponentially as the distance from the center of the PSAPD increases. As will be appreciated by those of ordinary skill in the art, the exemplary resistance profiles depicted in FIG. 2 are merely provided as example of possible resistance profiles of the resistive layer. Other resistance profiles or combinations of the provided profiles are possible and are encompassed by the present technique.

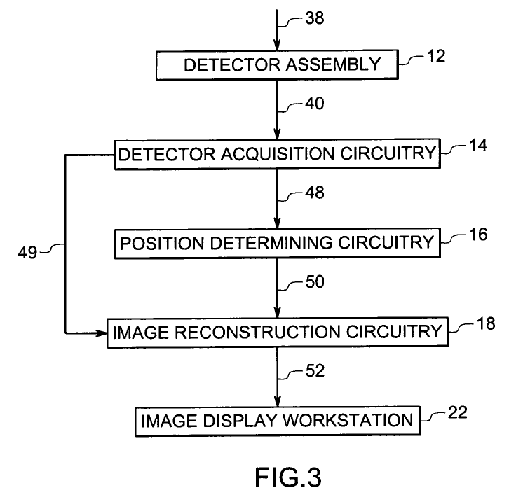

With the foregoing discussion in mind, we refer now to FIG. 3 that illustrates an exemplary embodiment of the present technique in which the image data is generated (such as via the detector acquisition circuitry 14 of FIG. 1) as a function of signal rise-times and signal amplitudes. In this embodiment, the detector acquisition circuitry 14 is configured to acquire signal rise-times and signal amplitudes from the detector assembly 12 and to determine an impact position based upon the rise-times and the amplitudes. As will be appreciated by those of ordinary skill in the art, the rise-times generated by a photon impact at each corner contact on the PSAPD is a function of the distance traveled by the electrical signal from the impact position of the photon on the top contact of the PSAPD. In the present embodiment, rise-time is defined as the time taken for a signal to rise from 10% of its peak value to 90% of its peak value, though other threshold values may also be used in other embodiments. Similarly, the amplitude of the electrical signals generated by a photon impact at each corner contact on the PSAPD is a function of the distance traveled by the electrical signal from the impact position of the photon on the top surface of the PSAPD.

Referring once again to FIG. 3, in the depicted embodiment, a plurality of gamma rays 38 strikes the detector assembly 12, generating electrical signals 40 for each gamma ray. As specified earlier, the detector assembly includes an array of PSAPDs as the detector elements. As will be appreciated by a person of ordinary skill in the art, the array may comprise a single detector element in certain exemplary implementations. However in practice the array may include any number of detector elements. Based on the position of impact of the gamma rays 38 on the detector assembly 12, each of the four corner contacts in each of the PSAPDs receive a fraction of the electrical signal of varying intensities, i.e., at least one electrical signal for each corner contact. The detector acquisition circuitry 14 acquires information in the form of electrical signals 40 from the detector assembly 12 when struck by a plurality of gamma rays 38, as discussed above. A corresponding rise time and amplitude (represented jointly by reference numeral 48) for each electrical signal 40 is determined for each gamma ray impact. In addition, for each gamma ray impact a corresponding time-stamp and energy measurement (represented jointly by reference numeral 49) are also generated by the detector acquisition circuitry 14 for use by the image reconstruction circuitry 18 in identifying gamma ray pairs that are coincident and that fall within a specified energy range. The rise times and amplitudes 48 are provided to the position determining circuitry 16 where the gamma ray impact positions 50 are determined based upon the differences in rise times and the differences in amplitudes measured for the electrical signals generated by each respective gamma ray impact. These positions and their associated time-stamps and energies are then processed by the image reconstruction circuitry 18 to re-construct a final image 52 which is then displayed on the image display system 22 or printed as a hard copy.

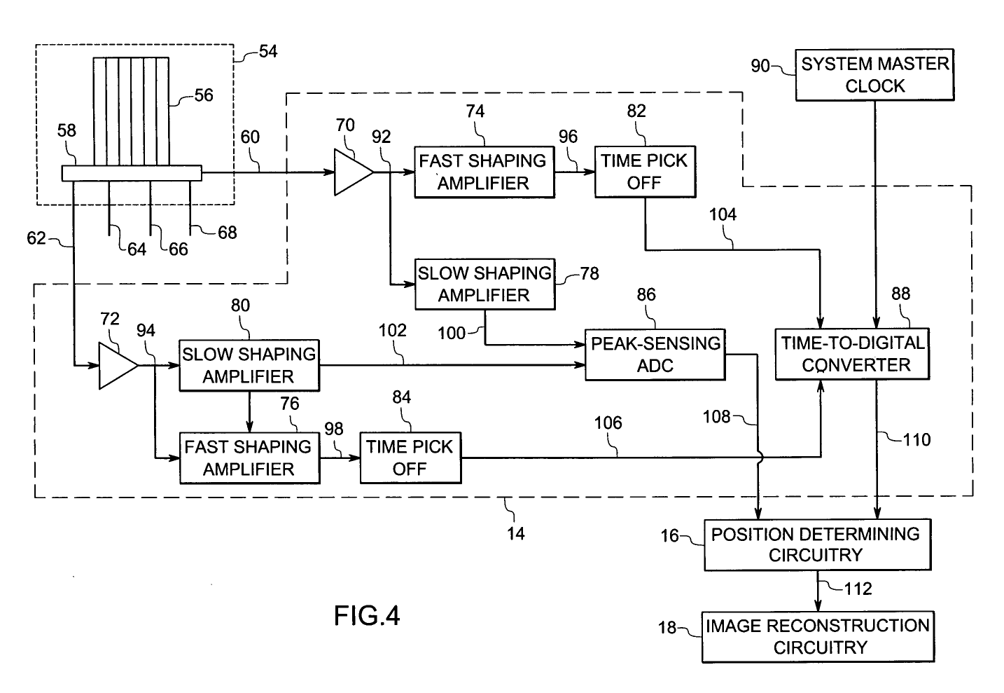

A detector element 54 and associated circuitry for use in embodiments of the present technique such as those depicted in FIG. 3 is depicted in FIG. 4. In the depicted embodiment of FIG. 4, the detector element 54 includes a scintillator unit 56 affixed to a PSAPD 58. As will be appreciated by a person skilled in the art, when gamma radiation impacts the scintillator unit 56, the scintillator unit 56 emits photons, which then impact on the PSAPD 58. As explained earlier, the PSAPD 58 includes a top surface contact and four bottom corner contacts. The top surface contact and the bottom corner contacts are connected to the detector acquisition circuitry 14 via, respectively, the top contact lead 60 and the respective bottom corner contact leads 62, 64, 66, and 68. To simplify clarification and discussion, only processing of signals from the top contact and one bottom contact are discussed. However, as will be appreciated by those of ordinary skill in the art, acquisition and processing of signals from the remaining bottom corner contacts, via bottom leads 64, 66, and 68, proceeds in the manner discussed with regard to bottom lead 62. The embodiment illustrated in FIG. 4 provides an indirect measurement of the signal rise-times at the corner contacts since the measured values depend on both the rise-time and the amplitude of the signals due to the effect of amplitude walk. In certain other implementations, these rise-time measurements may be further processed by the position determining circuitry 16 to correct for amplitude walk using the measured amplitudes and an initial estimate of the impact position based on only the amplitude of the electrical signals at the corner contacts of the PSAPD. Other techniques which are also known to those of ordinary skill in the art could be applied to directly measure the rise time of the electrical signals. The rise-times and amplitudes are themselves indirect measures of position information, which may in turn be used in combination with one another to determine position associated with impact of gamma rays on the detector element. In certain other implementations, the rise time of the electrical signal from the top surface of the PSAPD could be measured in addition to the rise times of the corner contact signals. The rise time of the signal from the top surface provides an additional measurement of the distance from the center of the detector to the impact position and could be used to further refine the final position estimate.

In the depicted embodiment of FIG. 4, the detector acquisition circuitry 14 includes pre-amplifiers 70 and 72; fast shaping amplifiers 74 and 76; slow shaping amplifiers 78 and 80; time pick off circuitry 82 and 84; a peak sensing analog-to-digital converter (ADC) 86 and a time-to-digital converter (TDC) 88. Also, as depicted, the position determining circuitry 16 processes the information from the detector acquisition circuitry to provide information on signal rise-times and signal amplitudes at each of the corner contacts 62-68 of the PSAPD 58. The position determining circuitry 16 uses the information on the signal rise-times and signal amplitudes to generate a position estimate that is further processed by the image reconstruction circuitry 18 to generate a reconstructed image. A system master clock 90 generates time references so that timing of gamma rays detected in the detector assembly 12 can be compared to determine coincident pairs of gamma rays. While the various sub-components are depicted as being associated with the detector acquisition circuitry 14 in the exemplary embodiment, one of ordinary skill in the art will appreciate that in other embodiments, other arrangements of the these or other subcomponents within the detector acquisition circuitry 14 and/or position determining circuitry 16 are contemplated.

In the depicted exemplary embodiment, the detector acquisition circuitry 14 includes pre-amplifiers 70 and 72 that receive and amplify electrical signals from the PSAPD 58 via the top lead 60 and the bottom lead 62 respectively. The output 92 from the pre-amplifier 70 is provided to both the fast-shaping amplifier 74 and the slow shaping amplifier 76. Similarly, the output 94 from the pre-amplifier 72 is provided to another pair of fast and slow shaping amplifiers 76 and 80 respectively. As will be appreciated by a person skilled in the art, shaping amplifiers are band-pass filters that are used to improve the signal-to-noise ratio for specific talks. The fast shaping amplifiers 74 and 76 have a high frequency (or “fast”) pass band, and they generates fast shaping signals 96 and 98 respectively that have been filtered to improve timing measurements (relative to timing measurements that would be made using the preamplifier pulse 94 without any further signal conditioning). The slow shaping amplifiers 78 and 80 have a low frequency (or “slow”) pass band, and generate slow shaping signals 100 and 102. The slow shaping signals 100 and 102 are filtered to improve pulse-amplitude measurements.

The fast shaping signal 96 is processed by the time pick off circuitry 82. The fast shaping signal 96 is further used to determine a time stamp (as discussed above) that is used in the reconstruction of the image to identify coincident pairs of gamma rays. In the depicted embodiment, the time pick off circuitry 82 is a constant fraction timing discriminator. Such discriminators are highly useful for coincidence counting i.e., when two events occur within a certain fixed time period, and are, therefore, useful in PET imaging techniques. As will be appreciated by a person skilled in the art, timing discriminators, such as the time pick off circuitry 82 in the present embodiment, are used to determine when a pulse occurs. The pulse in this case is the electrical signal from the top contact of the PSAPD 58. When such a pulse is detected, a pulse signal 104 is generated. Timing discriminators are typically classified into four different categories, namely constant-fraction, leading edge, crossover and digital signal processing timing discriminators. While in the depicted embodiment a constant-fraction timing discriminator is used; the other three types of timing discriminators may be used as appropriate in other implementations. The pulse signal 104 from the time pick off circuitry 82 is used as a trigger signal to initiate data acquisition.

As specified above, the signal from the lead 62 is fed to the pre-amplifier 72. The amplified signal 94from the pre-amplifier 72 is fed to the slow shaping amplifier 78 as well as to the fast shaping amplifier 76. The slow shaped output 102 signal is provided to the peak sensing ADC 86. The fast shaped signal 98 from the fast shaping amplifier 76 is provided to the time pick off circuitry 84, which in the depicted embodiment, is a leading-edge discriminator. As discussed above, however, other types of timing discriminators may be employed in other embodiments. The output 106 from the time pick off circuitry 84 is used as a trigger to stop data acquisition by the time to digital converter 88. Difference in the time pick off signal 104 and 106 provides rise-time information for the electrical signal at corner contact 62. In a similar manner, the rise-time information for the bottom contacts 64-68 is obtained. The slow shaped signal 102 is provided to the peak sensing ADC 86 that measures the pulse height of the slow shaped signal 102. Since the pulse height of the slow shaped signal is proportional to the charge collected by the corner contact 62 (in this exemplary embodiment), the pulse height indicates the charge collected by the corner contact 62. The pulse height, therefore, can be used as a measure of amplitude of the electrical signal at corner contact 62. Similarly, the amplitudes of the signals at the corner contacts 64-68 may be determined.

The peak sensing ADC 88 and the time to digital converter 90, here depicted as part of the position determining circuitry 16, produce output signals 108 and 110 respectively. The output 108 from the peak sensing ADC 86 provides information about the amplitude of the signal as determined from the signals acquired at the respective bottom contact. Conversely, the output 110 from the time to digital converter 88 provides information about the rise-time of the signal as determined from the signals acquired at the respective bottom contact. In the depicted embodiment, the signals input to the peak sensing ADC 86 and the time to digital converter 88 are analog in nature while respective the outputs 108 and 110 are digitized in the conversion process. The respective signals 108 and 110 are provided to position determining circuitry 16. The position determining circuitry 16, as described previously, generates a position estimate 112 based on the information contained in the signals 108 and 110. This position estimate 112 is provided to the image reconstruction circuitry 18 for reconstruction into an actual image that can be used for providing a proper diagnosis. Further, the detector acquisition circuitry 14 also records a time stamp, which is a measurement of the arrival time of the gamma ray. The time stamp is used to determine coincident gamma ray pairs that strike the detector assembly.

In accordance with certain aspects of the present technique, in one embodiment, the position determining circuitry 16 generates two independent position estimates; one based on the amplitude measurements and another, based on the rise-time measurements. The final position estimate is derived from an average or a weighted average of the two estimates. In another embodiment, the amplitude and rise-time signals for each corner contact are combined, either by simple averaging or a weighted average, and the combined signal is used to generate a position estimate indicating the impacts of the gamma rays. In yet another embodiment, the rise time and amplitude measurements are combined to generate a position estimate using a technique referred to as Maximum Likelihood Estimation. The present embodiment, as will be appreciated by a person skilled in the art, uses a model or prior measurements of signal amplitudes, rise-times, their respective noise distributions, and/or their conditional dependencies as a function of position to statistically estimate the position that would make the measured data most likely. In each of these embodiments, the process of obtaining position information by combining rise time and amplitude information provides improved resolution compared to the resolution obtained using rise times or amplitude alone.

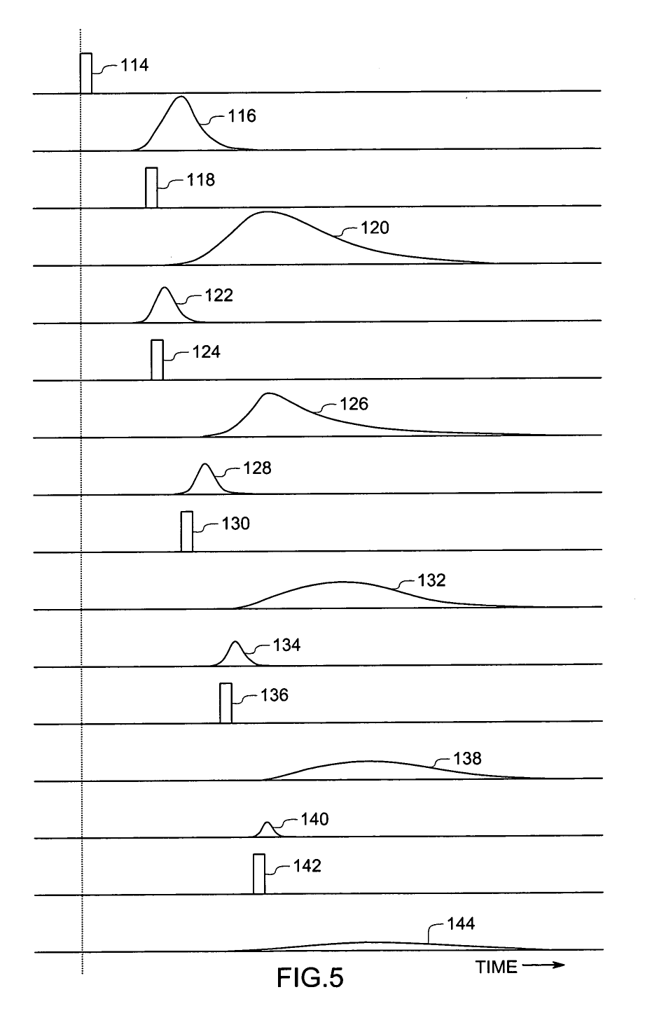

To further illustrate the concepts discussed with regard to FIG. 4, depictions of the various signals and outputs are provided in FIG. 5. The plots, all, share a common horizontal axis with respect to time. In this example, the emitted photons strike closer to the bottom corner contact 62 compared to bottom contacts 64, 66 and 68. In this example, fast shaping signal 96 represents the fast shaped signal from the top surface contact of the PSAPD 54. Pulse signal 98 represents the signal 104 from the time pick off circuitry 82 for the top surface contact of the PSAPD 54. Plot 114 represents the common start signal provided by the system master clock 90 to the time to digital converter 88. Plot 116 represents the fast shaped signal 96 generated based on the signal from the top surface contact 60 of the PSAPD illustrated in FIG. 4. Plot 118 represents the time pick off signal 104 generated from the time pick off circuitry 82 and that which is used for determining coincidence timing of the impact of gamma rays on the detector element. The time pick off signal 104 may further be used to determine relative timing of the signals from each of the corner contacts 62-68. Plot 120 represents the slow shaped signal 100 generated from the slow shaping amplifier 78 based on the signal 92. Plot 120 represents the pulse height proportional to the total charge collected by the top contact 60 of the PSAPD 58. Plot 122 represents the fast shaping signal 98 generated for the corner contact 62. Plot 124 represents the time pick off signal 106 generated for the corner contact 62. As explained previously, the difference between the time pick off signals represented by plots 118 and 124 is used to determine signal rise-time for the corner contact 62. Plot 126 represents the slow shaped signal 102 that provides information on the pulse height proportional to the charge collected by corner contact 62. Likewise, plots 128, 130 and 132 represent the fast shaped signal, the time pick off signal and the slow shaped signal generated for corner contact 64 in a manner similar and based on the discussion of FIG. 4 for corner contact 62. Subsequently, plots 134-138; and plots 140-144 represent the fast shaped signals, the time pick off signals and the slow shaped signals respectively for corner contacts 66 and 68 respectively. It must be particularly noted that plots 132, 138 and 144 represent the pulse heights proportional to charge collected at the corner contacts 64, 66 and 68 respectively. Similarly, plots 130, 136, and 142 represent the signal rise-times at the corner contacts 64, 66, and 68 respectively. As described previously, the pulse heights vary at each corner contact such that the pulse height measured at a contact corner is proportional to the proximity of the optical photon impacts to the contact corner, i.e., greater pulse heights correspond to a closer impact. As depicted, earlier rise times correspond to greater proximity as well.

In accordance with certain embodiments of the present technique, code or blocks of code, stored on a tangible, computer-readable medium, may configured to perform an act of acquiring both a plurality of rise-times and a plurality of amplitudes from the detector assembly. The code may also be used to determine a plurality of impact positions based on the acquired plurality of rise-times and the plurality of amplitudes. In certain exemplary implementations, code may also be used for obtaining time stamp information and/or energy measurement information from the detector assembly. Code may also be used to generate a position estimate based on the one of the plurality of impact positions, the time stamp information and/or the energy measurement information or their combinations. Further, code may be used to reconstruct an image based on the generated position estimate.

In accordance with certain other embodiments of the present technique, a method of manufacturing of a device for position sensing, the PSAPD for example, includes disposing a non-uniform resistive layer between a bottom surface of the position sensitive avalanche photodiode and a plurality of bottom contacts. Each of the bottom contacts establishes electrical contact with the bottom surface of the position sensitive avalanche photodiode through the non-uniform resistive layer. As explained previously and illustrated in FIG. 2, the non-uniform resistive layer may have one or more resistance profiles.

The various embodiments and aspects already described may comprise an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM), a read-only memory (ROM), an erasable programmable read-only memory (EPROM or flash memory), an optical fiber (optical), and a portable compact disc read-only memory (CDROM) (optical). Note that the computer readable medium may comprise paper or another suitable medium upon which the instructions are printed by mechanical and electronic means or be hand-written. For instance, the instructions can be electronically captured via optical scanning of the paper or other medium, then compiled, interpreted or otherwise processed in a suitable manner if necessary, and then stored in a computer readable memory.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An imaging system, comprising:
detector acquisition circuitry configured to acquire a plurality of rise-times and a plurality of amplitudes from a detector assembly comprising an array of one or more detector elements; and
position determining circuitry configured to determine a plurality of respective impact positions on each of the one or more detector elements based on at least the plurality of rise-times and the plurality of the amplitudes acquired by the detector acquisition circuitry.

2. The imaging system as recited in claim 1, further comprising image reconstruction circuitry configured to generate an image based on the plurality of impact positions determined by the position determining circuitry.

3. The imaging system as recited in claim 1, wherein the detector acquisition circuitry is configured to generate one of a time stamp information or energy measurement information.

4. The imaging system as recited in claim 3, comprising image reconstruction circuitry configured to generate an image based on one of the time stamp information, the energy measurement information, the plurality of impact positions or combinations thereof.

5. The system of claim 1, wherein the array of one or more detector elements comprises an array of position sensitive avalanche photodiodes.

6. The imaging system as recited in claim 5, wherein each position sensitive avalanche photodiode comprises a uniform resistive layer.

7. The imaging system as recited in claim 5, wherein each position sensitive avalanche photodiode comprises a non-uniform resistive layer.

8. The imaging system as recited in claim 1, further comprising a scintillator array configured to generate a plurality of photons to impact the detector assembly.

9. The imaging system of claim 1, further comprising a display workstation configured to display an image generated from the plurality of respective impact positions.

10-12. (canceled)

13. A device for position sensing, comprising:
a position sensitive avalanche photodiode configured to generate an electrical signal when impacted by one or more photons from an attenuated radiation beam, the position sensitive avalanche photodiode comprising:
a non-uniform resistive layer disposed between a bottom surface of the position sensitive avalanche photodiode and a plurality of bottom contacts, wherein the bottom surface of the position sensitive avalanche photodiode establishes electrical contact with the bottom contacts via the non-uniform resistive layer.

14. The device as recited in claim 13, wherein the non-uniform resistive layer exhibits a varying resistance profile.

15. A method for determining a position of a photon impact, comprising the steps of:
acquiring a plurality of rise times and a plurality of amplitudes from a position sensitive avalanche photodiode, wherein each rise time and each amplitude is a function of a distance between a respective contact of the position sensitive avalanche photodiode and a respective photon impact on the position sensitive photodiode; and
determining a position of the respective photon impact on the position sensitive avalanche photodiode based on the plurality of rise-times and the plurality of amplitudes.

16. The method as recited in claim 15, comprising determining the position of impact on the position sensitive avalanche photodiode based upon a non-linear relationship of at least one of the plurality of rise times and the plurality of amplitudes due to a a varying resistance profile of a resistive layer in the position sensitive avalanche photodiode.

17. The method as recited in claim 15, wherein determining the position of the respective photon impact comprises employing one of a simple averaging scheme, a weighted average scheme, a maximum likelihood estimation or combinations thereof.

18. A method for determining the position of a photon impact, comprising the steps of:
acquiring a plurality of rise times and a plurality of amplitudes from an array of one or more detector elements; and
determining the position of a photon impact on each of the detector elements based on the plurality of rise-times and the plurality of the amplitudes.

19. The method as recited in claim 18, comprising acquiring the plurality of rise times and the plurality of amplitudes from the array of one or more detector elements, wherein each of the detector elements comprises a position sensitive avalanche photodiode and wherein each rise time and each amplitude is a function of a distance between a respective contact of the position sensitive avalanche photodiode and a respective photon impact.

20. (canceled)

21. (canceled)

22. A computer-readable media, comprising:
code adapted to acquire a plurality of rise-times and a plurality of amplitudes from an array of one or more detector elements, wherein each rise-time and each amplitude is a function of a distance between a respective contact on each of the detector elements and a respective photon impact on the respective detector element; and
code adapted to determine a position of the photon impact on each of the detector elements based on the plurality of rise-times and the plurality of the amplitudes.

23. The computer-readable media as recited in claim 22, wherein the array of one or more detector elements comprises an array of one or more position sensitive avalanche photodiodes.

24. The computer-readable media as recited in claim 22, further comprising code adapted to acquire at least one of a time stamp information or an energy measurement information based on the respective photon impact on the respective detector element.

25. The computer-readable media as recited in claim 24, further comprising code adapted to generate an image based on one of the time stamp information, the energy management information, the position of photon impact or combinations thereof.

26. (canceled)

27. (canceled)
